(19) United States
(12) Patent Application Publication
(10) Pub. No.: US 2013/0016608 A1
(43) Pub. Date: Jan. 17, 2013

(54) Method of Reducing Signaling in Congested Network and Related Communication Device

(71) Applicant: Kundan Tiwari, Taoyuan County (TW)

(72) Inventor: Kundan Tiwari, Taoyuan County (TW)

(21) Appl. No.: 13/545,012

(22) Filed: Jul. 10, 2012

Related U.S. Application Data
(60) Provisional application No. 61/506,651, filed on Jul. 12, 2011.

(51) Int. Cl. H04W 28/10

(52) U.S. Cl. 370/230

(57) ABSTRACT

A method of reducing signaling in a congested core network for a mobile device is disclosed. The method comprises initiating a procedure when a back-off timer is running on the mobile device; receiving a message during the procedure; and treating a cell as Network Mode of Operation (NMO) II and initiating a location update procedure according to reception of the message, wherein the mobile device is combined attached for a packet switched (PS) service and a circuit switched (CS) service to a network operating in NMO I.

### CROSS REFERENCE TO RELATED APPLICATIONS

This application claims the benefit of U.S. Provisional Application No. 61/506,651, filed on Jul. 12, 2011 and entitled “Method to handle network initiated procedure when back off timer is running on the UE”, the contents of which are incorporated herein in their entirety.

### BACKGROUND OF THE INVENTION

1. Field of the Invention

The application relates to a method in a wireless communication system and related communication device, and more particularly, to method of reducing signaling in a congested network in a wireless communication system.

2. Description of the Prior Art

A long-term evolution (LTE) system supporting the 3GPP Rel-8 standard and/or the 3GPP Rel-9 standard is developed by the 3rd Generation Partnership Project (3GPP) as a successor of a universal mobile telecommunications system (UMTS), for further enhancing performance of the UMTS to satisfy users' increasing needs. The LTE system includes a new radio interface and radio network architecture that provides a high data rate, low latency, packet optimization, and improved system capacity and coverage. In the LTE system, a radio access network known as an evolved UTRAN (E-UTRAN) includes multiple evolved NBs (eNBs) for communicating with multiple user equipments (UEs), and communicates with a core network including a mobility management entity (MME), serving gateway, etc for Non Access Stratum (NAS) control. In UMTS system, a Serving GPRS Support Node (SGSN) is responsible for the delivery of data packets to the mobile devices back and forth within its geographical service area, including packet routing and transfer, mobility management (attach/detach and location management), logical link management, and authentication and charging functions. The MME also provides the control plane function for mobility between LTE and 2G/3G access networks with the S3 interface terminating at the MME from the SGSN.

NAS level congestion control contains the functions: “APN (access point name) based congestion control” and “General NAS level Mobility Management control”. The use of the APN based congestion control is for avoiding and handling of EMM and ESM signalling congestion associated with UEs with a particular APN. With General NAS level Mobility Management control, the MME may also use the reject of NAS level Mobility Management signaling requests under general congestion conditions.

When MME/SGSN performs NAS level congestion control, the MME/SGSN stores a Mobility Management back-off time and a Session Management back-off time. Then the MME/SGSN enforces the stored back-off time by immediately rejecting any subsequent MM/SM request from the UE and allocating a MM/SM back-off timer.

If the MME rejects Tracking Area Update request or Service request with a Mobility Management back-off timer which is larger than the sum of the UE's periodic TAU timer plus the Implicit Detach timer, the MME should adjust the mobile reachable timer and/or Implicit Detach timer such that the MME does not implicitly detach the UE while the Mobility Management back-off timer is running.

For a normal attached UE, if it gets rejection with a MM back-off timer due to TAU reject or service reject. The UE is normal attached (EMM-Registered state) but enters ECM-IDLE mode when the MM back-off timer is running. When MM back-off timer is running, the back-off UE is still allowed to make emergency call by PDN connection request with request type of emergency to an emergency APN. When the NAS signaling connection is built due to emergency PDN connection request and the UE returns from ECM-IDLE mode to ECM-Connected mode, the network stops the mobile reachable timer.

The network initiates the detach procedure by sending a DETACH REQUEST message to the UE. The network may include an EMM cause IE to specify the reason for the detach request. The network shall start timer T3422 . When receiving the DETACH REQUEST message and the detach type indicates “IMSI detach”, the UE shall not deactivate the EPS bearer context(s) including the default EPS bearer context. The UE shall set the MM update status to U2 NOT UPDATED. A UE may send a DETACH ACCEPT message to the network, and shall re-attach to non-EPS services by performing the combined tracking area updating procedure, sending a TRACKING AREA UPDATE REQUEST message with EPS update type IE indicating “combined TA/LA updating with IMSI attach”.

While the EMM/GMM back off timer is running, a UE can initiate emergency procedure or a priority user can initiates NAS procedure. The EMM/GMM back off timer will not be stopped while emergency call is ongoing or NAS procedure related to priority user is ongoing.

### SUMMARY OF THE INVENTION

A method of reducing signaling in a congested core network for a mobile device is disclosed.

A method of reducing signaling in a congested core network for a mobile device is disclosed. The method comprises initiating a procedure when a back-off timer is running on the mobile device; receiving a message during the procedure; and treating a cell as Network Mode of Operation (NMO) II and initiating a location update procedure according to reception of the message, wherein the mobile device is combined attached for a packet switched (PS) service and a circuit switched (CS) service to a network operating in NMO I.

A communication device for reducing signaling in a congested core network is disclosed. The communication device comprises means for initiating a procedure when a back-off timer is running on the mobile device; means for receiving a message during the procedure; and means for treating a cell as Network Mode of Operation (NMO) II and initiating a location update procedure according to reception of the message, wherein the communication device is combined attached for a packet switched (PS) service and a circuit switched (CS) service to a network operating in NMO I.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary mobile communication environment.

FIG. 2 is a schematic diagram of an exemplary communication device.

FIG. 3 is a flow chart of an exemplary process.

### DETAILED DESCRIPTION

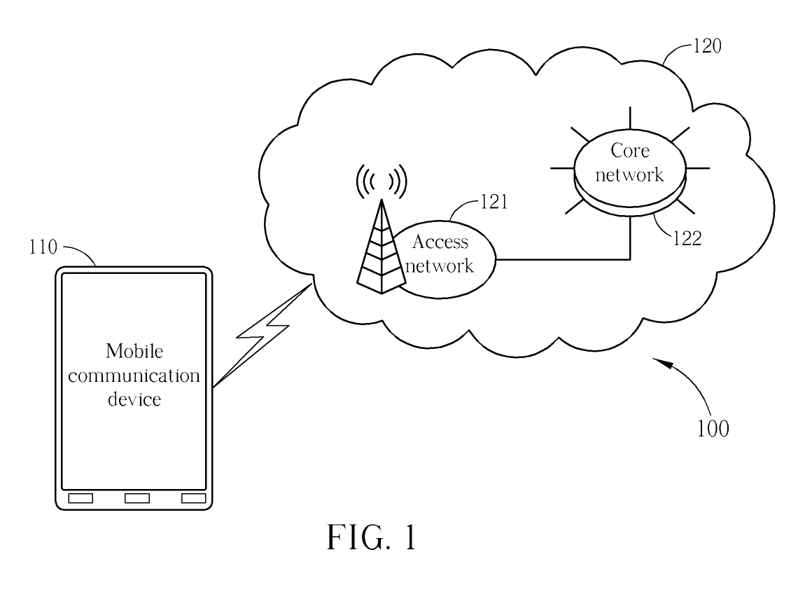

Please refer to FIG. 1, which is a block diagram illustrating a mobile communication environment 100 according to an embodiment of the invention. In the mobile communication environment 100, the mobile communication device 110 is wirelessly connected to the service network 120 for obtaining wireless services. The service network 120 comprises an access network (or called radio access network) 121 and a core network 122. The service network 120 may be a network in compliance with the Global System for Mobile Communication (GSM), Universal Mobile Telecommunications System (UMTS), or Evolved Packet System (EPS) technology. The access network 121 may be a GSM Edge Radio Access Network (GERAN) in the GSM technology, a UMTS Terrestrial Radio Access Network (UTRAN) in the WCDMA/HSPA technology, or an Evolved-UTRAN (E-UTRAN) in the LTE/LTE-Advanced technology, and the core network 122 may be a GSM core or General Packet Radio Service (GPRS) core in the GSM/UMTS system or an Evolved Packet Core (EPC) in the EPS system.

In LTE, the core network 122 includes a network control node, e.g. mobility management entity (MME). The MME is responsible for the delivery of data packets to the mobile devices back and forth within its geographical service area, including packet routing and transfer, mobility management (attach/detach and tracking area management), session management (PDN connection establishment/disconnect), logical link management, and authentication and charging functions. The MME can also serve as a local mobility anchor for inter-working with other RATs (e.g. GSM and UMTS). In UMTS, the core network includes a network control node, e.g. Serving GPRS Support Node (SGSN). The SGSN is responsible for the delivery of data packets to the mobile devices back and forth within its geographical service area, including packet routing and transfer, mobility management (attach/detach and tracking area management), session management (PDP Context establishment/disconnect), logical link management, and authentication and charging functions. In GSM, the core network includes a network control node, e.g. Mobile Switching Center (MSC). The MSC is responsible for the delivery of voice service in circuit switch manner to the mobile devices back and forth within its geographical service area, including mobility management (attach/detach and location area management), logical link management, and authentication and charging functions. The mobile communication devices 110 can be devices such as mobile phones, computer systems, etc. Besides, the access network and the mobile communication devices 110 can be seen as a transmitter or receiver according to transmission direction, e.g., for uplink, the mobile communication device 110 is the transmitter and the network is the receiver, and for downlink, the network is the transmitter and the mobile communication device 110 is the receiver.

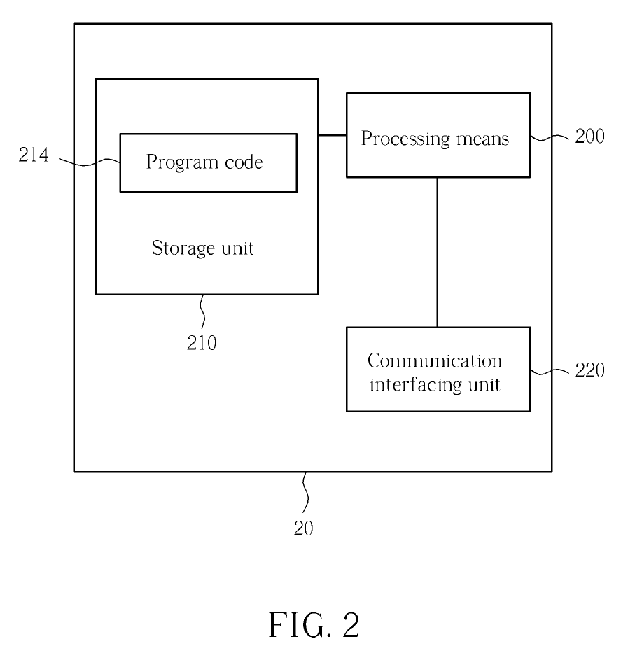

Please refer to FIG. 2, which is a schematic diagram of an exemplary communication device 20. The communication device 20 can be the mobile communication device 110 or the core network 122 shown in FIG. 1, but is not limited herein. The communication device 20 may include a processor 200 such as a microprocessor or an Application Specific Integrated Circuit (ASIC), a storage unit 210 and a communication interfacing unit 220. The storage unit 210 may be any data storage device that can store a program code 214, accessed by the processor 200. Examples of the storage unit 210 include but are not limited to a subscriber identity module (SIM), read-only memory (ROM), flash memory, random-access memory (RAM), CD-ROM/DVD-ROM, hard disk, and optical data storage device. The communication interfacing unit 220 is preferably a transceiver and can handle timer configuration according to processing results of the processor 200.

In the following embodiments, the service network 120 may be a GSM/UMTS/EPS network belonging to a specific PLMN, and the mobile communication device 110 maybe a Mobile Station (MS) or User Equipment (UE). The UMTS/EPS network is in compliance with the 3GPP TS 23.060/TS 23.401 specifications, 3GPP TS 24.008/TS 24.301 specifications, 3GPP TS 23.122 and/or other related UMTS/EPS specifications. Based on the technology used, the messages of Mobility Management (MM) operations may correspond to the GSM/UMTS/EPS technology, respectively, e.g. MM message for Location Area Update, GMM message for Routing Area Update, and EPS Mobility Management (EMM) message for Tracking Area Update.

When a normal attached mobile communication device 110 (EMM-Registered state) gets rejection with a MM back-off timer due to tracking area update reject or service reject. The mobile communication device 110 is normal attached but enters ECM-IDLE mode when the MM back-off timer is running. When the MM back-off timer is running, the back-off mobile communication device 110 is still allowed to make emergency call by PDN connectivity request with request type of emergency to the core network 122.

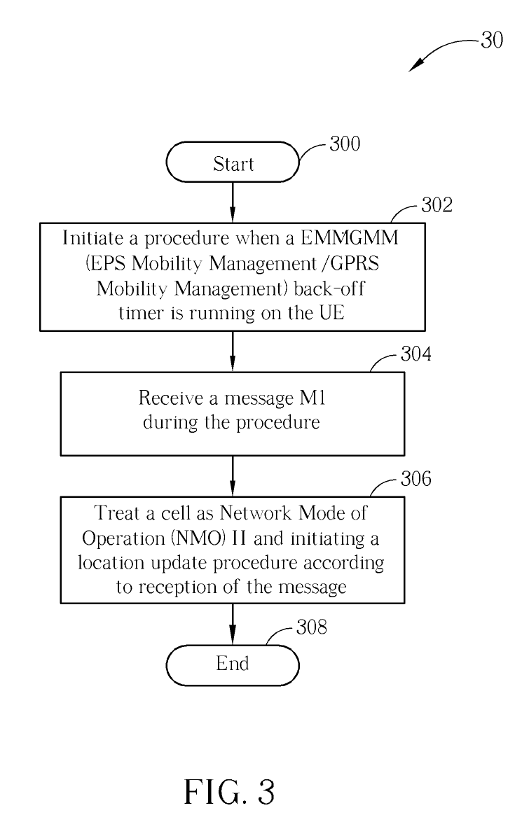

Please refer to FIG. 3, which is a flow chart of a process 30. The process 30 is used for reducing signaling in a congested core network for a UE. The congested core network can be the core network 122, which include a network control node, e.g. MME/SGSN/MSC. The UE can be the mobile communication device 110 in FIG. 1 and is combined attached for a packet switched (PS) service and a circuit switched (CS) service to an access network operating in NMOI. The process 30 may be complied in the program code 214 and includes the following steps:

Step 300: Start.

Step 302: Initiate a procedure when a EMM/GMM (EPS Mobility Management/GPRS Mobility Management) back-off timer is running on the UE.

Step 304: Receive a message M1 during the procedure.

Step 306: Treat a cell as Network Mode of Operation (NMO) II and initiating a location update procedure according to reception of the message

Step 308: End.

According to the process 30, the UE combined attached for the PS service and the CS service initiate the procedure while the EMM/GMM back off timer (e.g. timer T3346) is running on the UE. The procedure can be an emergency procedure or a NAS procedure. The EMM/GMM back-off timer is activated due to the congested core network. Then, the UE receives a message M1 when the procedure is ongoing and the EMM/GMM back-off timer is still running. The message M1 is used for performing detach and re-attach from the CS service. Preferably, the message M1 is a detach request message with a detach type “IMSI detach”. Instead of performing detach and re-attach from the CS service, the UE treats the cell a NMO II and initiates the location update procedure to attach for the CS service according to the reception of the message M1 (at the beginning, the cell was operating in NMOI). In the NMO II, the UE performs separate GPRS Attach and IMSI Attach procedures to register in both the PS and CS Domains. The UE sends a location update request message to initiate the location update procedure. Compared to the prior art, the process 30 can reduce signaling in the congested core network since the UE does not detach and re-attach from the CS service, which may cause more signaling in the congested network.

When receiving the message M1, the UE still processes the message M1 and sends a detach accept message to the congested network. On the other hand, the UE keeps running the back-off timer during the procedure instead of stopping the back-off timer. Since the back-off is running, the UE is not allowed to initiate GMM/EMM messages except for the priority user, emergency services or responding to paging.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the UE combined attached for the PS service and the CS service initiate while the EMM/GMM back off timer (e.g. timer T3346) is running on the UE. The UE receives a message (e.g. a detach request message with a detach type “IMSI detach”) when the procedure is ongoing and the EMM/GMM back-off timer is still running. Then, the UE treats the cell a NMO II and initiates the location update procedure to attach for the CS service according to the reception of the message. Therefore, the UE does not perform detach and re-attach from the CS service, which can reduce signaling in the congested core network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of reducing signaling in a congested core network for a mobile device, the method comprising:
initiating a procedure when a back-off timer is running on the mobile device;
receiving a message during the procedure; and
treating a cell as Network Mode of Operation (NMO) II and
initiating a location update procedure according to reception of the message;
wherein the mobile device is combined attached for a packet switched (PS) service and a circuit switched (CS) service to a network operating in NMO I.

2. The method of claim 1, wherein the message is a detach request message with a detach type and the detach type is IMSI detach.

3. The method of claim 1, wherein the procedure is a NAS (non-access stratum) procedure or an emergency procedure.

4. The method of claim 1 further comprising keeping running the back-off timer during the procedure, wherein the back-off timer is an EMM (EPS Mobility Management) back-off timer or a GMM (GPRS Mobility Management) back-off timer.

5. The method of claim 1 further comprising processing the message and sending a detach accept message to the congested core network when receiving the message.

6. The method of claim 1, wherein initiating the location update procedure comprises sending a location updating request message to the congested network.

7. A communication device for reducing signaling in a congested core network, the communication device comprising:
means for initiating a procedure when a back-off timer is running on the mobile device;
means for receiving a message during the procedure; and
means for treating a cell as Network Mode of Operation (NMO) II and initiating a location update procedure according to reception of the message;
wherein the communication device is combined attached for a packet switched (PS) service and a circuit switched (CS) service to a network operating in NMO I.

8. The communication device of claim 7, wherein the message is a detach request message with a detach type and the detach type is IMSI detach.

9. The communication device of claim 7, wherein the procedure is a NAS (non-access stratum) procedure or an emergency procedure.

10. The communication device of claim 7 further comprising means for keeping running the back-off timer during the procedure, wherein the back-off timer is an EMM (EPS Mobility Management) back-off timer or a GMM (GPRS Mobility Management) back-off timer.

11. The communication device of claim 7 further comprising means for processing the message and sending a detach accept message to the congested core network when receiving the message.

12. The communication device of claim 7, wherein the means for initiating the location update procedure further sends a location updating request message to the congested network.
